(19) United States
(12) Patent Application Publication
(10) Pub. No.: US 2024/0122410 A1
(43) Pub. Date: Apr. 18, 2024

(54) Pulverization Device

(71) Applicant: Lucius LaFromboise, Duluth, MN (US)

(72) Inventor: Lucius LaFromboise, Duluth, MN (US)

(21) Appl. No.: 18/046,063

(22) Filed: Oct. 12, 2022

(51) Int. Cl. A47J 43/07; A23G 1/06; A47J 43/044; B02C 4/02; B02C 4/12

(52) U.S. Cl. CPC A47J 43/0711; A23G 1/06; A47J 43/044; B02C 4/02; B02C 4/12; A47J 2043/0449

(57) ABSTRACT

A pulverizing assembly for a mixer having a drive pin may include a primary rotation about a central axis following a circular path and a secondary rotation about a drive pin axis. The pulverizing assembly may include a mounting hub configured for operable coupling to the drive pin and an auxiliary coupling operably couple to the mounting hub to follow the circular path about the central axis and rotate relative to the mounting hub thereby being isolated from rotation about the drive pin axis. The pulverizing assembly may also include a framework extending from the auxiliary coupling and including a laterally extending axle, extending generally orthogonal to the central and drive pin axes. A grinding wheel may be operably arranged on the axle and configured to pulverize material against a surface as the axle moves and the grinding wheel rolls.

### TECHNOLOGICAL FIELD

The present disclosure relates to devices for grinding, mashing, crushing, milling, beating, or otherwise comminuting or pulverizing materials. More particularly, the present disclosure relates to devices for pulverizing beans, seeds or other grains in connection with food preparation. Still more particularly, the present disclosure relates to attachments for consumer mixers that provide for grinding cocoa beans to produce chocolate.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Chocolate can be created through a variety of processes which often incorporate a pulverizing step. Other food products, such as nut butters and spice pastes, also involve a pulverizing step. The pulverizing step of these processes often begins with beans or other grains and results in a mud, slurry, or paste by reducing the grains to fine particles. Devices on the market tend to be manufactured for, and marketed towards, professional and industrial users. The existing devices may be heavy, expensive, and may require advanced skill to operate, which can make the devices less accessible by smaller confectioners or more average consumers.

### SUMMARY

The following presents a simplified summary of one or more embodiments of the present disclosure in order to provide a basic understanding of such embodiments. This summary is not an extensive overview of all contemplated embodiments and is intended to neither identify key or critical elements of all embodiments, nor delineate the scope of any or all embodiments.

Aspects of the present disclosure relate to a pulverizing assembly for a mixer having a drive pin that has a primary rotation about a central axis following a circular path and a secondary rotation about a drive pin axis. The pulverizing assembly may include a mounting hub, auxiliary coupling, a framework, and a grinding wheel. The mounting hub may be configured for operable coupling to the drive pin to follow the circular path about the central axis and to rotate with the drive pin about the drive pin axis. The auxiliary coupling may operably couple to the mounting hub to follow the circular path about the central axis and rotate relative to the mounting hub thereby being isolated from rotation about the drive pin axis. The framework may extend from the auxiliary coupling and may include a laterally extending axle, extending generally orthogonal to the central and drive pin axes. The grinding wheel may be operably arranged on the axle and configured to pulverize material against a surface as the axle moves and the grinding wheel rolls synchronously with the drive pin about the central axis.

Other aspects of the present disclosure relate to a mixer having a drive pin that has a primary rotation about a central axis following a circular path and a secondary rotation about a drive pin axis coupled with a pulverizing assembly. The pulverizing assembly may include a mounting hub, auxiliary coupling, a framework, and a grinding wheel. The mounting hub may be configured for operable coupling to the drive pin to follow the circular path about the central axis and to rotate with the drive pin about the drive pin axis. The auxiliary coupling may operably couple to the mounting hub to follow the circular path about the central axis and rotate relative to the mounting hub thereby being isolated from rotation about the drive pin axis. The framework may extend from the auxiliary coupling and may include a laterally extending axle, extending generally orthogonal to the central and drive pin axes. The grinding wheel may be operably arranged on the axle and configured to pulverize material against a surface as the axle moves and the grinding wheel rolls synchronously with the drive pin about the central axis.

Other aspects of the present disclosure relate to methods of grinding comestible material with a mixer having a drive pin that has a primary rotation about a central axis following a circular path and a secondary rotation about a drive pin axis. The method may include attaching a base to a mixer bowl to form a grinding surface, attaching a pulverizing assembly to the drive pin, adding comestible material to the grinding surface, and activating the mixer. The pulverizing assembly may include a grinding wheel, configured to pulverize material against the grinding surface. The pulverizing assembly may be configured to rotate about the central axis while a portion of the pulverizing assembly may be isolated from rotation about the drive pin axis where the primary rotation of the drive pin about the central axis rotates the pulverizing assembly and grinds the comestible material against the grinding surface.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a mixer with an adapter system in accordance with one or more embodiments of the present disclosure.

FIG. 2 is a front view of the mixer of FIG. 1, with the mixing bowl removed and revealing a pulverizing assembly and base of the adapter system, in accordance with one or more embodiments of the present disclosure.

FIG. 3 is a perspective view of the pulverizing assembly and base of FIGS. 1 and 2 shown in isolation, in accordance with one or more embodiments of the present disclosure.

FIG. 4 is a perspective view of the pulverizing assembly of FIGS. 1-3 shown in isolation in accordance with one or more embodiments of the present disclosure.

FIG. 5 is a perspective view of a mounting hub of the pulverizing assembly of FIGS. 1-4 in accordance with one or more embodiments of the present disclosure.

FIG. 6 is a cross-sectional view of the pulverizing assembly of FIGS. 1-4 positioned on the base of FIGS. 2 and 3 arranged in a mixing bowl in accordance with one or more embodiments of the present disclosure.

FIG. 7 is a perspective view of the base of FIGS. 2, 3, and 6 in accordance with one or more embodiments of the present disclosure.

### DETAILED DESCRIPTION

One or more embodiments of the present disclosure may pertain to a device that can be used to make chocolate or other products involving grinding and mixing solid materials into a paste, liquid, or other fine particulate form. Such grinding and mixing can be performed by the rotation of grinding wheels and paddles around a central axis in a basin where the grinding wheels pulverize the desired material, and the paddles scrape excess material from the side of the basin. In one or more embodiments the device may include an adapter system for converting a consumer level mixer into a pulverizing device. This adapter may allow users to conveniently grind food products on a small consumer scale without the use of a separate appliance by adapting a common household mixer into a pulverization device. In one or more embodiments, a pulverizing assembly of the system may be particularly configured to neutralize the planetary or epicyclic drive of a common household mixer into a single axis of rotation about a central axis when attached to the mixer's drive shaft. In addition, a base of the system may be configured to modify a bowl into a flat-bottomed basin to provide a surface for pulverization. As such, aspects of the present disclosure may allow consumers and/or small confectioners to produce products such as chocolate, nut butter, and the like by helping to avoid significant investments in larger, more expensive, and less user-friendly equipment.

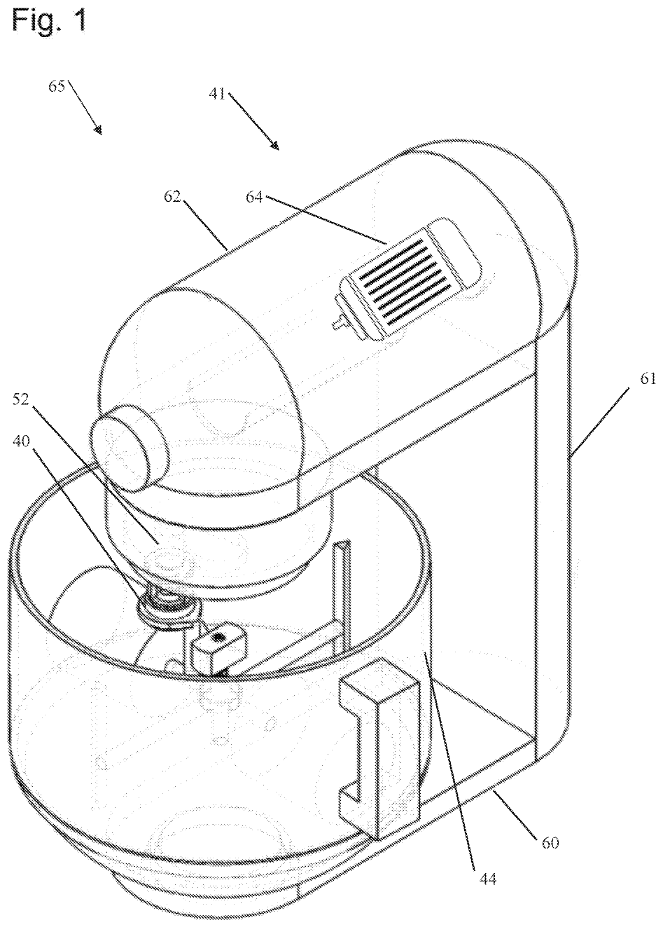

FIG. 1 is a perspective view of a mixer 41, according to one or more examples. In particular, the mixer 41 shown is sized and configured for at home or countertop use. The mixer 41 may have a base portion 60, a neck 61, an arm 62, an electric drive motor 64, and a drive pin 52. The mixer 41 may also include a bowl 44. Each of these are discussed in turn.

The base portion 60 is shown in FIG. 1. The base portion 60 of the mixer 41 may be configured to support the mixer 41 and provide stability in multiple directions from tipping and sliding. The base portion 60 may have a wide footprint for contacting the surface it is set on and may have rubberized portions or feet to dampen vibrations and provide lateral traction. The base portion 60 may have a front and a back, where the front may provide a mount or receptacle so that the bowl 44 of the mixer 41 can be firmly attached when operating and removed for pouring bowl contents and cleaning. The back of the base portion 60 may attach to the neck 61. In other examples, the bowl 44 and neck 61 may be supported by a different part of the base portion 60 or another aspect of the mixer 41.

The neck 61 of the mixer 41 may be configured to support the arm 62 of the mixer 41 in spaced apart relations above the base portion 60 of the mixer where the arm 62 and base portion 60 run generally parallel along the length of each. The neck 61 may connect to the back of the base portion 60 and may extend from the base portion 60 generally vertically and generally perpendicular to the generally flat surface supporting the base portion 60. The mixing arm 62 may be connected to the end of the neck 61 opposite the base portion 60, such that the neck 61 supports the weight of the arm 62. The neck 61 may be removably coupled to the base portion 60 and arm 62, or it may be permanently or integrally connected to either or both.

With continued reference to FIG. 1, the arm 62 may be configured for operably supporting the mixer drive pin 52 above the bowl 44 to allow mechanical power to be delivered to the drive pin 52 and any mixing implement extending downward therefrom. The arm 62 may extend generally horizontally in the direction of the front of the base portion 60. The arm 62 may enclose or house the electric drive motor 64 and/or mechanical elements that transfer operable power from the electric drive motor 64 to the drive pin 52. The arm 62 may, thus, include a housing arranged on a substructure extending from the neck 61. The substructure and/or housing may be relatively rigid to provide for the cantilevering nature of the mixer arm 62 as it extends forward from the neck 61 attached at the back of the base portion 60. In one or more examples, the arm 62 may be pivotally coupled to the neck 61 so that the arm 62 can be raised to allow easy attachment/detachment of mixing implements and/or easy removal of the bowl 44. The arm 62 may also be rigidly coupled to the neck 61 or may have a locking mechanism to lock the arm 62 in the operable position once the bowl 44 and mixing implement are in place, for example.

The electric drive motor 64 is shown in a breakaway portion of FIG. 1. The electric drive motor 64 may be configured to convert electrical power to mechanical rotation to drive the mixer 41. The electric drive motor 64 may be internal to the mixer 41 and connected to the mixer drive pin 52 by various gears forming a drive train and/or other drive means. The electric drive motor 64 may be started from buttons and switches on the external portion of the mixer 41. The drive motor 64 may have multiple or variable operating speeds and may be controlled by electronics. The drive pin 52 may be arranged on an end of the electric drive motor drivetrain such that operation of the electric drive motor 64 drives the drive pin 52.

The drivetrain may be configured to transfer power from the electric drive motor 64 to the drive pin 52. The last stage of the drivetrain may be a planetary gearset. The planetary gearset may have a sun gear, a ring gear, and one or more planet gears. The planetary gearset may be placed with its axis of rotation perpendicular to a horizontal plane defined by the base portion 60 and perpendicular to which the arm 62 is offset from the base portion 60. In some embodiments the sun gear may be fixed with respect to the arm 62, while the ring gear is free to rotate. In other embodiments, the ring gear may be fixed with respect to the arm 62, while the sun gear is free to rotate. In still other embodiments, neither the sun nor ring gear may be fixed with respect to the arm 62. The drive pin 52 may be connected to the center axis of one of the planet gears. Other approaches to transferring mechanical power from the motor to the drive pin may be provided.

The drive pin 52 is shown in FIG. 1. The drive pin 52 may be configured to transfer power from the drivetrain to the mixing implement. The drive pin 52 may extend downward from the bottom of the front portion of the mixer arm 62 at the end of the drivetrain. The drive pin 52 may be designed to couple with various mixing implements and may be of various designs allowing for rigid attachment as well as quick release. The drive pin may be configured to move along a circular path about a central axis of the mixer 41. Movement of the drive pin 52 about the central axis of the mixer 41 may be referred to as primary rotation. The drive pin 52 may also be configured to rotate about an axis extending parallel to the central axis of the mixer 41 and through the center of the drive pin 52, referred to as the drive pin axis. This rotation about the drive pin axis of the drive pin 52 may be referred to as secondary rotation. The mixer 41 may generate primary rotation and secondary rotation of the drive pin through the use of a planetary gearset oriented to be in a horizontal plane at or near the arm 62, where the drive pin 52 is connected to a vertically extending axis of a planet gear. Under this configuration, when either the sun gear or ring gear is turned by the drivetrain, the planet gear may rotate about its own vertical axis and simultaneously rotate around the center axis of the planetary gearset.

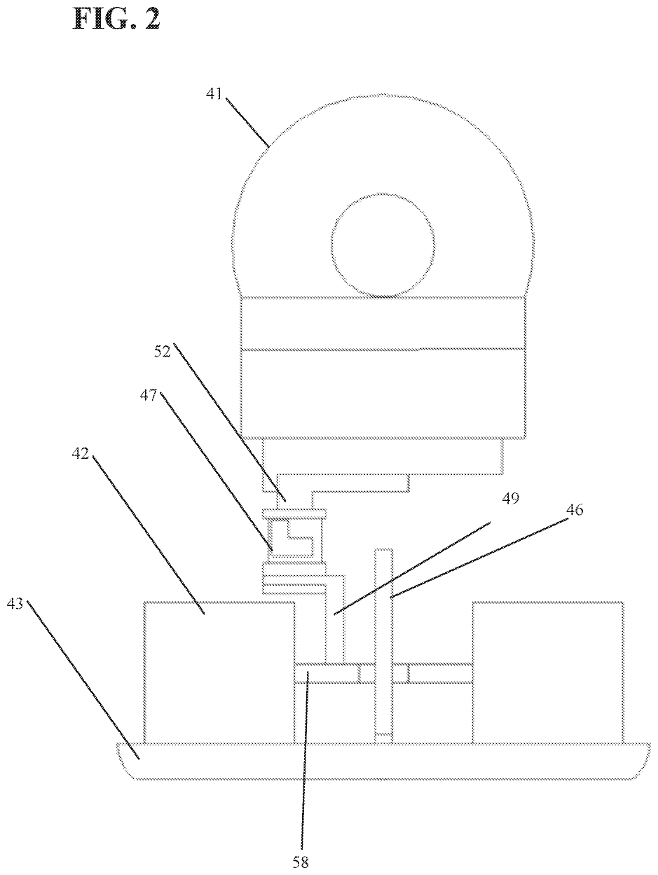

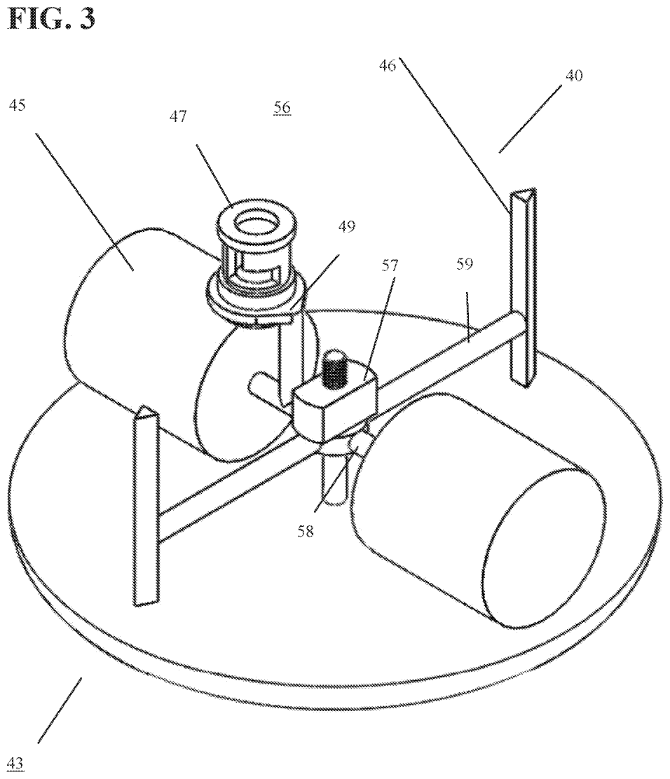

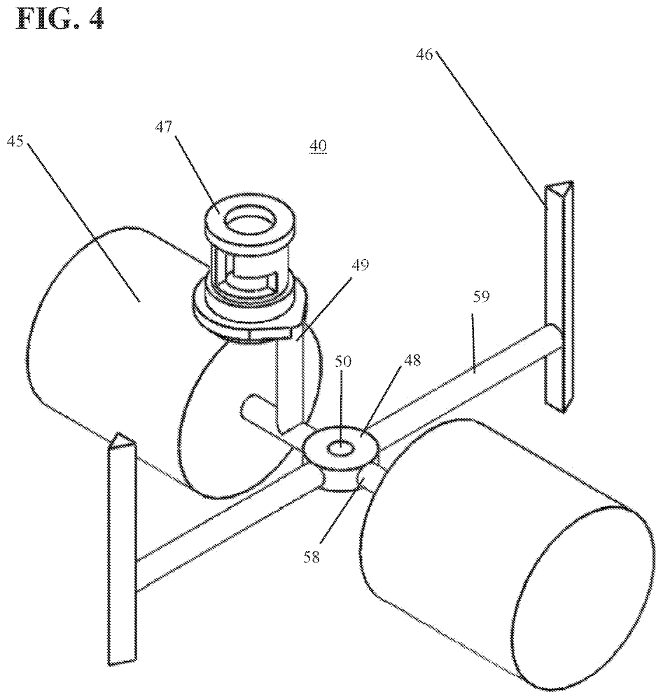

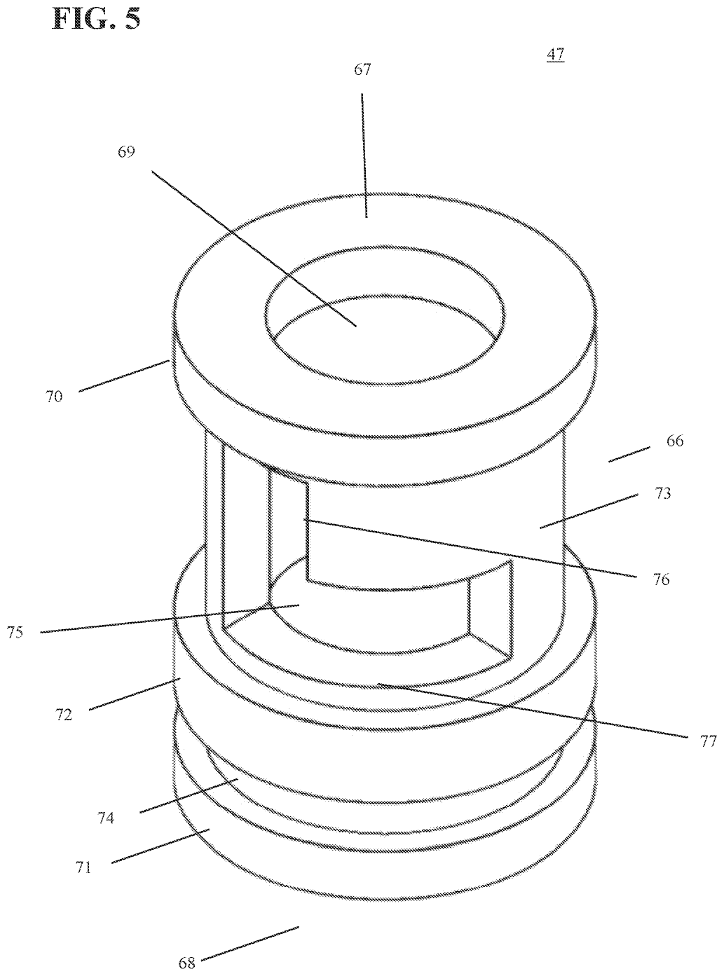

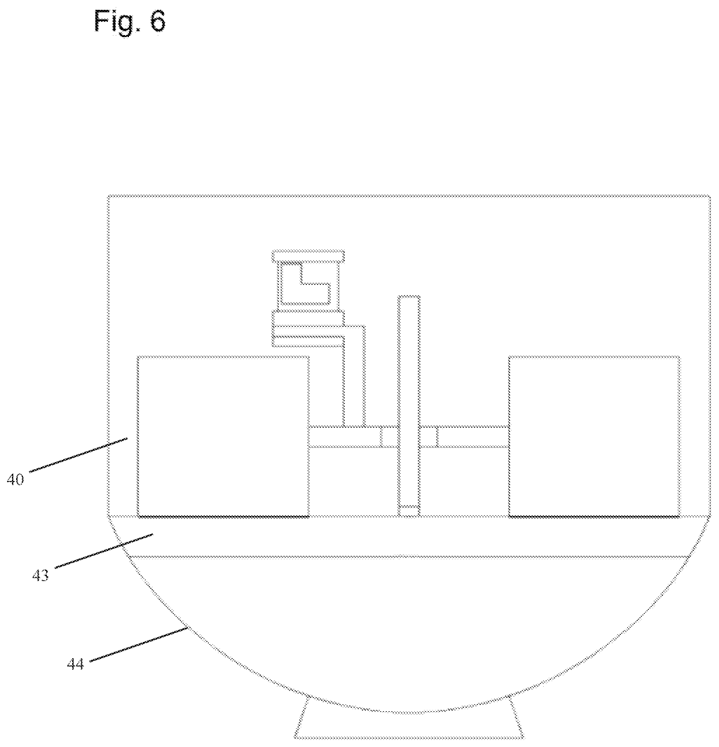

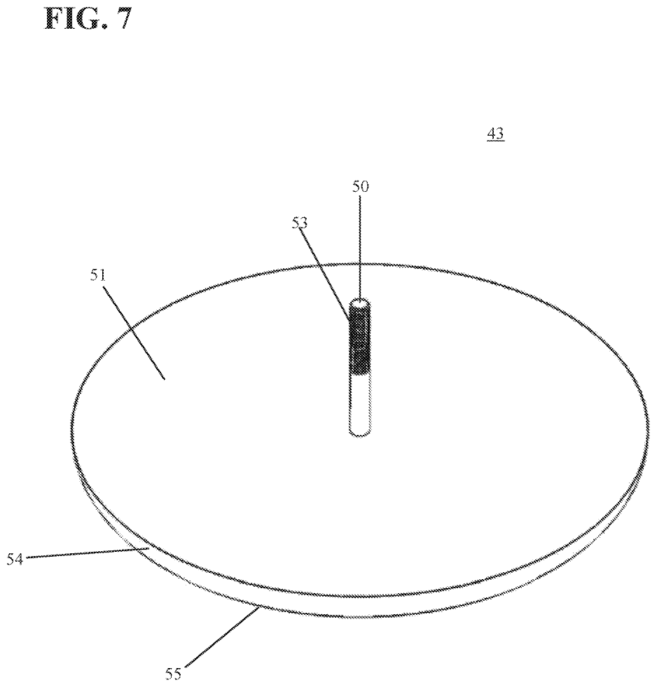

As discussed in more detail below, an adaptor system 56 may be used that allows the mixer 41 to perform a pulverization operation using the primary rotation of the drive pin 52 and isolating the secondary rotation. Together, the mixer 41 and the adapter system 56 may be configured for pulverizing grains or other materials to create a paste or slurry of finer particles. FIG. 2 shows a front view of the mixer 41 in conjunction with the adapter system 56. The adapter system 56 may include a base 43 and a pulverizing assembly 40. FIG. 3 shows the adapter system 56 in isolation from the mixer 41 and shows both the base 43 and the pulverizing assembly 40. Separately, FIGS. 4-5 show details of the pulverizing assembly and FIGS. 6-7 show details of the base. Each of these parts of the adapter system 56 will be taken in turn.

Turning now to the pulverizing assembly, reference is made to FIGS. 4 and 5. FIG. 4 shows one possible example of a pulverizing assembly. The pulverizing assembly may be configured to convert a mixer into a pulverizing device. The pulverizing assembly 40 may include components such as a framework, grinding wheels 45, scraping paddles 46, a mounting hub 47, and an auxiliary coupling 49. Each of these components are discussed below.

FIG. 4. shows an example embodiment of a framework. The framework may be configured to provide a structure that enables rotation of the pulverizing assembly 40 about the central axis of the mixer 41. The framework may also establish a link between the auxiliary coupling 49 and the grinding wheels 45 and scraping paddles 46. The framework may include a central coupling 48, an axle 58, and a mounting bar 59.

FIG. 4 shows the central coupling 48. The central coupling 48 may be used to join the axle 58, and mounting bar 59 such that they rotate in unison about the central axis of the mixer 41 when in operation. As shown in FIG. 4, the central coupling 48 may include an annular disc having a thickness and a cylindrical hole extending therethrough. The cylindrical hole may be adapted to interface with the base 43 to establish a rotational center point for the pulverizing assembly 40. The diameter of the cylindrical hole may vary to accommodate the base 43. The axis formed through the center of the cylindrical hole may be aligned with the central axis of the mixer 41 when the adapter system 56 is in the operational state. The central coupling 48 may be a separate piece or integral to the axle 58 and mounting bar 59.

With continued reference to FIG. 4, the axle 58 may be configured for rotation about a central axis to walk one or more grinding wheels around the surface of the base. The axle 58 may laterally extend in two opposite directions from the central coupling 48 to respective free ends. As discussed in more detail below, one or more grinding wheels 45 may be arranged on the axle 58. The axle 58 may be oriented perpendicular to the central axis of the mixer 41 such that the axle 58 is substantially parallel with the base 43 during operation. The axle may be integrally attached to the central coupling 48 or be a separate component fixed to the central coupling 48. A plurality of axles may be used to accommodate the same number of grinding wheels 45. The length of an individual axle 58 varies depending on the size of the central coupling 48, the base 43, and grinding wheel 45. The length of the axle 58 may be less than the radius of the base 43 minus the outer radius of the central coupling 48. The diameter of the axle 58 can vary depending on the material choice and strength needed. FIG. 4 shows an axle 58 that is approximately the thickness of the central coupling 48. In one embodiment the axles 58 are made of metal and are cylindrical in shape.

Still referring to FIG. 4, the mounting bar may be configured for rotation about a central axis to carry one or more scrapers around an inner surface of a bowl or other base element. The mounting bar 59 may extend in two opposite directions from the central coupling 48 to respective free ends. The mounting bar 59 may be oriented perpendicular to the central axis of the mixer 41 such that the mounting bar 59 is substantially parallel with the base 43 during operation. In one or more examples, as shown, the mounting bar may also be arranged substantially perpendicular to the axle 58. A scraping paddle may be mounted on the free end of the mounting bar and may be arranged substantially perpendicular to the mounting bar. The distance between the base 43 and the mounting bar 59 may be determined by the radius of the grinding wheel 45. That is, the axle 58 and the mounting bar 59 may run from the central coupling 48 and be arranged in the same plane. Alternatively, the central coupling may have a larger thickness allowing the axle and mounting bars to be in different planes or multiple central couplings separated vertically by one or more posts may be provided. A plurality of mounting bars 59 may be used to accommodate the same number of scraping paddles 46. The length of an individual mounting bar 59 varies depending on the size of the central coupling 48, the base 43, and scraping paddle 46. The length may be determined by the distance from the central coupling 48 to the circumferential edge of the base 43 minus the width of the scraping paddle 46. The shape of the mounting bar 59 may vary depending on the material choice and strength needed. In one embodiment the mounting bars 59 are made of metal and are cylindrical in shape.

As mentioned, and in addition to the framework, the pulverization assembly may include grinding wheels 45, scraping paddles 46, a mounting hub 47, and an auxiliary coupling 49. The grinding wheels 45, shown in FIG. 4, may be configured to pulverize material by compacting it between the grinding wheels 45 and the base 43. The grinding wheels 45 are generally cylindrical with circular plane surfaces spaced from one another to define a length and arranged on ends of the wheels. A cylindrical surface may extend between the two circular plane surfaces. The length of the grinding wheel and, as such, the length of the cylindrical surface of the grinding wheel 45 may vary depending on the desired use and diameter of the base 43. The circular planes may have center points that may define a rotational axis of the grinding wheel. The rotational axes of at least two grinding wheels may be aligned with one another and the wheels may be arranged on the axle or shaft 58. The wheels may be supported on the shaft 58 with bearings or another relatively low friction engagement. In one or more examples, the grinding wheels 45 may be solid and relatively dense, heavy elements that provides a relatively large inertia for grinding operations. The grinding wheels 45 may vary in number, position, dimension, material, surface finish, or other characteristics based upon the desired purpose and method of grinding.

In one or more embodiments, the grinding wheel 45 may be a roller on an axle 58 which allows for rotation about the axle 58. The grinding wheel 45 could be fixed to the axle 58 such that it slides across the base 43 during operation instead of rolling across the base about the axle 58. The grinding wheel 45 could also be made of many rollers together in a stack. FIG. 4 shows one embodiment with two grinding wheels 45, but other embodiments could use only one wheel or many wheels. One possible embodiment places the grinding wheels 45 symmetrically about the central coupling 48. In one embodiment, the length of the grinding wheel 45 may be approximately the distance between the outer circumference of the base 43 and the connection point of the auxiliary coupling 49 to the axle 58. In another embodiment, shown in FIG. 4 the length of the grinding wheel 45 is shorter than the distance from circumference the base 43 to the auxiliary coupling 49, but still covers a majority of the surface area of the base 43 during operation. In one or more examples, the grinding wheels may include rigid, smooth, textured, or malleable grinding wheels 45. FIG. 4 shows smooth grinding wheels 45 with a relatively hard outer surface such as quartz, marble, granite, or other natural stone or synthetic surface. Textured grinding wheels 45 may have a checkered surface akin to a waffle maker, or slits running either direction. A grinding wheel 45 made from many smaller rollers may have gaps between rollers which function as slits in the grinding wheel 45. Grinding wheels 45 may be made of many materials. For instance, grinding wheels 45 of ceramic, metal, stone, marble, granite, or quartz may be useful to attain a desired hardness, or grinding wheels 45 of plastic or rubber may be desired if elasticity is necessary for the grinding process.

Turning now to the scraping paddles 46 and with continued reference to FIG. 4, the scraping paddles 46 may be configured to remove material from the sides of a mixing bowl and continually reintroduce the material onto a base for pulverization by the grinding wheels. The scraping paddles 46 may include scrapers placed substantially perpendicular relative to the substantially flat base 43, such that the outer edge may contact the sides of a mixing bowl 44. The scraper may be a triangular prism shape as shown in FIG. 4. The triangular prism shape may include three side faces, one top face, one bottom face, and one scraping edge. The three side faces may be oriented such that an edge along the length of the shape interfaces with an inside face of the mixing bowl 44 while in use. The scraping paddles 46 may rotate about the central rod axis 50 by way of being fixed to the mounting bar 59. The connection to the mounting bar 59 may be rigid or flexible. In one or more embodiments, one side face may be perpendicularly integral to the mounting bar 59. In one embodiment, one side face may not be integral to the mounting bar 59 but connected by a fastener, screw, adhesive, or a combination thereof. The scraping edge may contact a side of the mixing bowl 44 as shown in FIG. 1. When rotating, the three-side face and the scraping edge of the vertical scrapers may move about the surface of the mixing bowl 44 to scrape material off the walls of the mixing bowl 44 and return said material into the path of the grinding wheel 45. The vertical scraper may be integral to the axle 59 in such a way so as to modify an angle the scraping edge interacts with the surface of the mixing bowl 44. The angle of the scraping edge may vary depending on the desired contact with the mixing bowl but is generally perpendicular to the mounting bar 59. The angle of the scraping edge may then also vary its contact with the surface of the mixing bowl 44 for the purpose of maximizing the reintegration of displaced material into the path of the grinding wheel 45. The scraping paddle 46 may be parallel to the mixing bowl 44 side wall so as to maximize the length of contact between the two. When rotating, the bottom face of the scraping paddle may be in contact with the substantially flat base 43. The scraping paddle may also be pivotally connected to the mounting bar, such that the scraping paddle may vary in angle to the mounting bar in order to maximize the contact between the scraping edge and the mixing bowl side wall.

In one embodiment, the scraping paddles 46 may also vary at least in number, shape, dimension, and material. In one embodiment, the number of scraping paddles 46 and the number of grinding wheels 45 may match in number. Alternatively, the number of scraping paddles 46 and the number of grinding wheels 45 may not match in number. In one embodiment, the positions of the grinding wheels 45 and scraping paddles 46 may alternate about the central coupling 48. For example, as shown, there may be two grinding wheels and two scraping paddles that alternate along a circumference of the assembly such that a scraper is arranged between each of the grinding wheels. In this configuration, material in the mixing bowl 44 may interact with the grinding wheels 45 and the scraping paddles 46 in an alternating fashion. Alternatively, the positions of the grinding wheels 45 and the scraping paddles 46 may be sequential about the central coupling 48, such that material in the mixing bowl 44 may contact one or more grinding wheels 45 followed by contact with one or more scraping paddles 46. In one embodiment, the scraping paddle may be a triangular prism with a top triangular end, a bottom triangular end and an outer edge for scraping, connected integral or otherwise, to the mounting bar 59. In another embodiment, the scraping paddles 46 may be a scraping blade connected, integral or otherwise, to the mounting bar 59. In another embodiment, the scraping paddle 46 may be cylindrical with a top circular end, a bottom circular end, and a curved outer edge for scraping, connected integral or otherwise, to the mounting bar 59. In one embodiment, the shape of the scraping paddles 46 may vary to maximize the reintegration of displaced material in the mixing bowl 44 to the path of the grinding wheels 45. The scraping paddles 46 may be made of many materials. In one embodiment, the scraping edge contacting the mixing bowl 44 may be made of a flexible material, such as silicone, in order to create a resilient sealing effect when scraping.

FIG. 4 also shows a mounting hub 47 in conjunction with the rest of the pulverizing assembly. The mounting hub 47 may be configured to engage the drive pin 52 of the mixer 41 and rotate with the drive pin 52 (e.g., with both secondary and primary rotation) to drive rotational motion of the framework together with the grinding wheels 45 and the scraping paddles 46. FIG. 5 shows the mounting hub 47 in isolation. The mounting hub may form a generally tubular body 66 with a generally circular top end 67 and a generally circular bottom end 68 where a generally circular through hole 69 runs from the center of the circular top end 67 through the circular bottom end 68. The diameter of the circular through hole 69 may remain constant while the outer diameter of the tubular body 66 may vary in steps such that a series of collars increasing the outer diameter of the tubular body 66 are formed about the length of the tubular body 66. The collars may have the same outer diameter amongst each other with the remainder of the tubular body having a constant diameter less than that of the collars. A top 70 and bottom 71 collar may form the ends of the tubular body 66 in a shape akin to a spool. A third, middle 72, collar may be located near the bottom end 68 to form two distinct areas between collars. The First area may be between the top collar and the middle collar and referred to as the locking area 73. The second area may be between the middle collar and the bottom collar and referred to as the auxiliary coupling area 74. The locking area 73 is meant to engage the drive pin 52 and maintain contact during operation.

FIG. 5 shows one embodiment of the present disclosure where the locking area 73 may have an L-shaped hollow 75 that extends radially from the through hole 69 to the outer diameter of the tubular body 66. The L-shaped hollow 75 is positioned such that the short leg 76 of the L-shaped hollow runs along the length of the tubular body 66, while the long leg 77 of the L-shaped hollow runs along the circumference of the tubular body 66. The L-shape may be sized such that the long leg 77 of the L-shaped hollow 75 forms an arc length along the circumference of the tubular body 66 between ⅕ and ½ of the total circumference of the outer diameter of the tubular body 66. A drive pin 52 may enter through the top end 67 of the through hole and lock to the mounting hub 47 through the L-shaped hollow 75. The mounting hub 47 may lock to the drive pin 52 such that the mounting hub 47 spins about the drive pin 52 with the secondary rotation of the drive pin 52. The auxiliary coupling area 74 may connect the auxiliary coupling 49 to the mounting hub 47. The auxiliary coupling area 74 may have the same outer diameter as the locking area 73 and may not have any additional geometry. The canyon formed along the circumference of the tubular body 66 by the middle 72 and lower 71 collars enable an auxiliary coupling 49 to engage the auxiliary coupling area 74 while still allowing the mounting hub 47 to spin about the drive pin 52. In other embodiments, the mounting hub 47 may incorporate alternative attachment mechanisms to account for the type of mixer in use and the corresponding attachment type. In the present embodiment, the mounting hub 47 rotates about the mixer drive pin 52 with the secondary rotation of the drive pin 52 and about the central axis of the mixer 41 with the primary rotation of the mixer 41.

Turning to the auxiliary coupling 49 and referring back to FIG. 4, the auxiliary coupling 49 may function to link the mounting hub 47 to the axle 58 and isolate the rotation of the drive pin and hub 47 from the framework. In particular, the auxiliary coupling 49 may form a channel to engage the auxiliary coupling area 74 of the mounting hub 47, such that the mounting hub 47 may spin about the drive pin 52 without moving the auxiliary coupling 49. The channel may be a variety of shapes, for example a U-shape, where the auxiliary coupling area 74 of the mounting hub 47 slots into the U-shaped channel. The legs of the U-shaped Channel may have a length roughly equivalent to the diameter of the bottom collar 71. The distance between legs of the U-shaped channel may vary such that the auxiliary coupling area 74 forms a close fit with the inside edge of the U-shaped channel. When linked to the Mounting hub 47, the legs of the U-shaped channel of the auxiliary coupling are generally parallel with the bottom end of the mounting hub 47. A bar may extend from a first end at the base of the U-shaped channel and extend normal to the legs of the U-shaped channel to a second end. The second end may form an integral connection to the axle 58.

As may be appreciated from the above-mentioned discussion, the pulverization assembly may be advantageous by isolating the rotational motion of the drive pin about the offset axis while leveraging the rotational motion about the central axis and, as such, making the assembly useful for mixers having both types of motion. The pulverization assembly may also provide for grinding and scraping the material based on the rotational motion of the system.

Turning now to a discussion of the base 43, reference is made to FIGS. 6 and 7. The base 43 provides a surface suitable for grinding, on which, the pulverizing assembly 40 sits. As shown in FIG. 6, the base may be configured for stable and sealed arrangement in a mixing bowl such that the grinding wheels 45 of the pulverizing assembly 40 may interface with a top surface 51 to grind material.

FIG. 7 shows the base 43 in isolation. As shown, the base 43 may be a generally circular element with a circular outer edge having a center point. The base 43 may have a bottom surface 55 and a substantially flat top surface 51 and the outer circumferential edge may be an angled edge 54. When the pulverizing assembly 40 is attached to the base 43, the grinding wheels 45 sit on the top surface 51. The distance between the top surface 51 of the base 43 and the center of the axle 58 may be determined by the radius of the grinding wheel 45 because the axle 58 runs through the center point of the circular plane of the grinding wheel 45. The base 43 may also include a central rod 53 rising normal to the top surface 51 from the center point of the circular outer edge. The central rod 53 may engage the framework of the pulverizing assembly 40, such that the center of the central rod 53 forms a central rod axis 50 along the length of the central rod 53. When the base is in the operable position, the central rod axis 50 may run in line with the central axis of the mixer 41. One or both of the angled side edge 54 and the bottom surface 55 of the base 43 may be coated in a resilient material such as silicone to facilitate a secure, stable, and/or watertight fit with the bowl 44 of a mixer 41. The central rod 53 may be partially or completely threaded to accommodate a tensioner nut 57 for additional stability or may be entirely unthreaded. In one or more embodiments, the base 43 and/or the top surface 51 may be made or coated with a relatively hard material such as metal, ceramic, marble, quartz, granite or other stone, or other hard material such that the base and/or its top surface resists scratching, denting, pitting, or other deformation while the grinding wheels 45 press material against it. In one embodiment, the side surface 54 of the base 43 is angled such that the top surface 51 of the base 43 has a larger area than the bottom surface 55 of the base 43. This angle may be of any degree necessary to accommodate the curved interior surface of a mixing bowl 44 and facilitate a secure fit. The side 54 and bottom 55 surfaces of the base 43 may also be coated in a resilient or elastic material to create a watertight seal between the base 43 and mixer bowl 44 as well as to limit damage to a mixing bowl 44 by way of the contact between the base and the mixing bowl 44.

In operation and use, a user may implement the adapter system 56 by placing the base 43 in a mixing bowl 44 and securing the pulverizing assembly 40 to the drive pin 52 of the mixer 41. The user may also place a selected amount of cocoa beans or other grains or material in the mixing bowl and on the surface of the platform portion. The arm of the mixer may be lowered to position the pulverizing assembly in the bowl and to rest the grinding wheels on the surface of the platform portion amidst the material that has been placed in the bowl. A user may then activate the mixer. Upon doing so, the grinding wheels 45 and scraping paddles 46 of pulverizing assembly 40 may rotate about the central rod 53 of the base 43 such that the grinding wheels 45 are in contact with the top surface 51 of the base 43 and the scraping paddles 46 are in contact with the interior surface of the mixing bowl 44. During rotation, the contact between the grinding wheels 45 and the base 43 may act to pulverize solid material added to the mixing bowl 44 while creating heat in the form of friction. The contact between the scraping paddles 46 and the interior surface of the mixing bowl 44 acts to move strayed material back onto the base 43.

Specifically, a user may attach a pulverizing assembly 40 to a mixer drive pin 52. This connection may be located near the single-pin connection mechanism of commercial mixers, or by any other connecting mechanism found on a mixer drive pin 52. A user may also attach a base 43 to the mixing bowl 44 by lowering it into the mixer bowl 44 such that it is substantially parallel with the flat bottom of the mixing bowl 44 and pressing downward to compress a peripheral seal coating against the interior surface of the mixing bowl 44 in order to create a substantially or completely watertight seal. Upon attachment of both the pulverizing assembly 40 and the base 43, the user may connect the components by way of the mixer's activation mechanism, whether this be by lowering the mixer head, raising the mixer bowl 44, or otherwise manipulating the mixer 41 in accordance with its operating procedure. This connection ultimately involves threading the base's rod 53 through the central coupling 48 of the pulverizing assembly 40. In some embodiments, the user may secure a tensioner nut 57 on the base's rod 53 to provide additional stability to the connection. FIG. 3 shows the adapter system 56 in isolation without the mixer 41. As shown, the adapter system 56 may include a pulverizing assembly 40 for engaging the drive pin of the mixer 41 and a base 43 for engaging the bowl 44 such that a flat surface for grinding is created. A pulverizing assembly 40 may connect to a base 43 by way of the union between the pulverizing assembly's central coupling 48 and the base's rod 53, allowing grinding wheels 45 to be in direct contact with the top surface 51 of the base 43.

After use, the pulverizing assembly 40 and the base 43 may be separated from each other in the reverse manner from which they were connected, in accordance with the deactivation mechanism of the particular mixer 41 being used. In some embodiments, the pulverizing assembly 40 may then be disconnected from the mixer drive shaft 52 by rotating the mounting hub and pulling the pulverizing assembly 40 away from the mixer drive shaft 52. Other embodiments may allow for alternative separation procedures in accordance with the connection mechanism of the particular mixer 41 being used. The base 43 may be removed from the mixing bowl 44 by pulling upward on the base's rod 53. A user may ease this process by pulling the base's peripheral seal coating away from the mixing bowl 44 while pulling on the base's rod 53 to break the seal created during its earlier connection.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “vertical”, or “round”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed:

1. A pulverizing assembly for a mixer having a drive pin that has a primary rotation about a central axis following a circular path and a secondary rotation about a drive pin axis, the pulverizing assembly comprising:
a mounting hub configured for operable coupling to the drive pin to follow the circular path about the central axis and to rotate with the drive pin about the drive pin axis;
an auxiliary coupling operably coupled to the mounting hub to follow the circular path about the central axis and to rotate relative to the mounting hub thereby being isolated from rotation about the drive pin axis;
a framework extending from the auxiliary coupling and comprising a laterally extending axle extending generally orthogonal to the central and drive pin axes; and
a grinding wheel operably arranged on the axle and configured to pulverize material against a surface as the axle moves and the grinding wheel rolls synchronously with the drive pin about the central axis.

2. The pulverizing assembly of claim 1 further comprising one or more scraping paddles configured to reincorporate displaced material into the pulverizing assembly.

3. The pulverizing assembly of claim 2 wherein the paddles form a peripheral seal against a bowl.

4. The pulverizing assembly of claim 1 further comprising a base adapted for securing within a bowl of the mixer and providing a surface for grinding, the base comprising a rigid plate having a substantially flat roller surface on a top side of the rigid plate.

5. The pulverizing assembly of claim 4 further comprising a central rod extending normally from the surface of the base in line with the central axis.

6. The pulverizing assembly of claim 4 wherein the base further comprises a peripheral seal adapted to secure the base in a bowl and create a watertight seal between a bottom side of the base and the inside surface of the bowl.

7. A pulverizing device comprising:
a mixer having a drive pin that has a primary rotation about a central axis following a circular path and a secondary rotation about a drive pin axis; and
a pulverizing assembly, comprising:
a mounting hub configured for operable coupling to the drive pin to follow the circular path about the central axis and to rotate with the drive pin about the drive pin axis;
an auxiliary coupling operably coupled to the mounting hub to follow the circular path about the central axis and to rotate relative to the mounting hub thereby being isolated from rotation about the drive pin axis;
a framework extending from the auxiliary coupling and comprising a laterally extending axle extending generally orthogonal to the central and drive pin axes;
a grinding wheel operably arranged on the axle and configured to pulverize material against a surface as the axle moves and grinding wheel rolls synchronously with the drive pin about the central axis.

8. The pulverizing device of claim 7 further comprising one or more scraping paddles configured to reincorporate displaced material into the pulverizing assembly.

9. The pulverizing device of claim 8 wherein the paddles form a peripheral seal against a bowl.

10. The pulverizing device of claim 7 further comprising a base adapted for securing within a bowl of the mixer and providing a surface for grinding, the base comprising a rigid plate having a substantially flat roller surface on a top side of the rigid plate.

11. The pulverizing device of claim 10 further comprising a central rod extending normally from the surface of the base in line with the central axis.

12. The pulverizing device of claim 10 wherein the base further comprises a peripheral seal adapter to secure the base in a bowl and create a watertight seal between a bottom side of the base and the inside surface of the bowl.

13. A method of grinding comestible material with a mixer having a drive pin that has a primary rotation about a central axis following a circular path and a secondary rotation about a drive pin axis, the method comprising:
attaching a base to a mixer bowl to form a grinding surface;
attaching a pulverizing assembly to the drive pin, the pulverizing assembly having a grinding wheel configured to pulverize material against the grinding surface, the pulverizing assembly configured to rotate about the central axis while a portion of the pulverizing assembly is isolated from rotation about the drive pin axis;
adding comestible material to the grinding surface; and
activating the mixer, wherein the primary rotation of the drive pin about the central axis rotates the pulverizing assembly and grinds the comestible material against the grinding surface.

14. The method of claim 13 wherein the pulverizing assembly further comprises scraping paddles configured to scrape the bowl to reincorporate displaced material into the grinding process.

15. The method of claim 13, wherein the comestible material is cocoa beans.

16. The method of claim 13, wherein the comestible material is nuts.

17. The method of claim 13, further comprising tipping an arm of the mixer into a mixing position with the pulverizing assembly attached.

18. The method of claim 17, wherein the base comprises a rod and the pulverizing assembly comprises a central coupling and the method further comprises aligning the central coupling with the central rod when tipping the arm.

19. The method of claim 13, further comprising raising the mixer bowl from a filling position to a mixing position.

20. The method of claim 13, further comprising removing the ground comestible from the mixer bowl.
